(19) United States
(12) Patent Application Publication
(10) Pub. No.: US 2014/0081184 A1
(43) Pub. Date: Mar. 20, 2014

(54) Kneed-A-Hand

(71) Applicant: Gilbert Brian Fredrick, Torrance, CA (US)

(72) Inventor: Gilbert Brian Fredrick, Torrance, CA (US)

(73) Assignee: GILBERT BRIAN FREDRICK, TORRANCE, CA (US)

(21) Appl. No.: 13/573,408

(22) Filed: Sep. 14, 2012

(51) Int. Cl. A61H 99/00

(52) U.S. Cl. CPC A61H 99/00
USPC 601/23

(57) ABSTRACT

Kneed-A-Hand is a practical device strap worn over the knee that enables its user to lift/raise their leg(s). Kneed-A-Hand measures approximately fourteen inches in length and three quarters inch in width. This strap comprises a main strap that is circular in design to keep the knee at the center. It is manufactured of lightweight, breathable material such as cotton or spandex. The proximal strap lies above the knee and contains a secondary hand strap for lifting the knee. Kneed-A-Hand secures to the knee with a side strap that wraps around the back of the knee and fastens with Velcro or other similar hook and loop fastener. To fit both average and large knees, the loop part of the fastener extends to cover approximately seven inches and the potion cover approximately four to five inches. When wearing Kneed-A-Hand the user simply pulls the hand strap to lift their leg.

### FIELD OF THE INVENTION

The present invention pertains to the field of orthopedic devices, and more specifically to the field of knee orthopedic aids.

### BACKGROUND OF THE INVENTION

The prior art has put forth several designs for knee orthopedic aids. Among these are:

U.S. Pat. No. 7,479,121 to Thomas P. Branch describes an inflatable bladder position a distance from a joint is attached to an external structural support which crosses the joint but does not support it. By inflating the bladder one limb segment is forced towards the external support thereby increasing the ranges of motion of that joint.

U.S. Pat. No. 7,172,522 to Charles David Harvey describes a device used to train a basketball player to use the proper technique while performing a layup basketball shot. The device attaches to the player's shooting arm and to the leg on the same side of the body as the shooting arm, which is the leg the player is supposed to raise when executing a layup. The device pulls on the player's leg when he raises his arm in the shooting motion, reminding the player to raise that leg instead of the opposite leg.

U.S. Pat. No. 4,463,947 to Steve Green, Vicki Green, Daniel A. Kloenne, Greg E. Kloenne and Amy E. Kloenne describes a knee and leg orthopedic exercising device used by a person seated in a chair. The device is a wide leg rest that may accommodate both legs of the user although it also may be used for one leg at a time. The device is shaped like an inverted T. The user holds two straps and as the person extends their leg to push against the floorboard, the device rolls forward on elongated wheels.

None of these prior art references describe the present invention.

### SUMMARY OF THE INVENTION

It is an object of the present invention to provide an assistive strap for lifting and raising a leg at the knee.

### BRIEF DESCRIPTION OF THE DRAWINGS

FIG. 1 is a front perspective view showing a secondary hand strap, back straps and stitching.

FIG. 2 is a back perspective view showing the two main straps and velcro™ on back straps.

FIG. 3 is a front and a side functional view showing the present invention on the right leg of a standing person.

FIG. 4 is a front functional perspective showing the present invention on the right knee of a wearer seated in a chair with their knee bent.

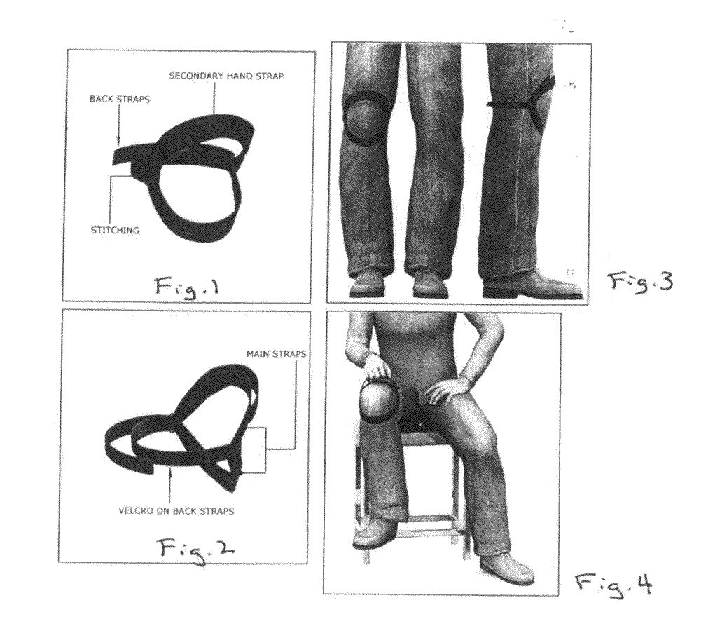

### DETAILED DESCRIPTION OF THE INVENTION

Most inventions fill a relatively small need or perform a specialized and limited function. If that need is shared by a sufficient number of consumers, the invention may have a great potential for success. Many people have limited mobility in their legs. Climbing stairs or getting into a car is challenging for those who suffer from knee pain, obesity and back problems.

The present invention, hereinafter referred to as the Kneed A Hand is a practical device strap to aid its user to lift and raise their leg(s). The Kneed A Hand measures approximately fourteen inches in length and three quarters inch in width. The strap comprises a main strap that is circular in design to keep the knee cap in the center. This strap is manufactured in a lightweight and breathable material such as cotton and spandex, for example. The proximal strap, which lies above the knee cap, contains a secondary hand strap for lifting the knee. The strap is placed over the knee cap, situated just above and below the knee. It secures to the knee with a side strap which wraps around the back of the knee and fastens together with Velcro or a similar hook and loop fastener. To fit both average size knees and large knees, the pad or loop part of the fastener extends to cover a minimum of approximately seven inches starting approximately one inch from the stitch line where the strap attaches to the apparatus. The hook portion of the fastener extends approximately four to five inches from the outer end of the strap. When wearing the Kneed A Hand, the user simply pulls the hand strap to lift their leg.

The Kneed A Hand is a simple and convenient device to aid in raising the knee or leg. The Kneed A Hand provides consumers with more independence as they help themselves to lift a knee or leg. For many people who suffer from limited mobility and find it difficult to climb stairs or get in and out of their cars, the Kneed A Hand assists them tremendously and protects their independence. A morbidly obese person climbing stairs reaches down and pulls the strap, inconspicuously lifting their leg up to the next step. The device is very lightweight and does not interfere with the user's daily activities. The Kneed A Hand is a beneficial aid for those who are recovering from surgery and the elderly. Fabricated of the highest quality materials and engineered for a long working life, the Kneed A Hand is an affordable device.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claim.

1. An assistive strap for lifting and raising a knee, essentially as described herein.
